(19) United States
(12) Patent Application Publication
(10) Pub. No.: US 2009/0098829 A1
(43) Pub. Date: Apr. 16, 2009

(54) SYSTEM FOR SECURING ELECTRICAL APPARATUS

(75) Inventor: Johnny Jensen, Kerteminde (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: POWER SECURE DEVELOPMENT APS, Kerteminde (DK)

(21) Appl. No.: 12/298,450

(22) PCT Filed: Apr. 26, 2007
(86) PCT No.: PCT/DK07/00196

§ 371 Date: Jan. 2, 2009

(30) Foreign Application Priority Data
Apr. 26, 2006 (DK) PA 2006 00592

(51) Int. Cl. H04B 1/00

(52) U.S. Cl. 455/68

(57) ABSTRACT

A system and a method for securing electric apparatus, that includes at least one transmitter transmitting at least one coded signal, and where the system includes at least one electric apparatus interacting with at least one decoder. To prevent electric apparatus from being used in other places than where intended, a one-way communication system causes the apparatus to lose their practical value if they are stolen. Activation of the electric apparatus is conditional on the transmitter transmitting a coded signal to at least one decoder that receives the coded signal and interacts with at least one electronic switch for establishing power supply to the apparatus. By using a device that switches off the power supply or other essential electric circuit for the electric apparatus in case that the decoder does not receive and decode the transmitted signals, it is possible to protect electric apparatus very efficiently against theft.

### BACKGROUND OF THE INVENTION

1. Field of the Invention

The present invention concerns a system and a method for securing electric apparatus, the system including at least one transmitter transmitting at least one coded signal, where the system includes at least one electric apparatus interacting with at least one decoder.

2. Description of Related Art

In Denmark and other industrialized countries, many electric apparatus are stolen, including computers, flat screens, televisions, printers and music systems. Even though alarms have been installed in many places, within a few minutes, a thief may localize and steal electric apparatus for a considerable amount of money. The stolen apparatus may then be resold and used in other places.

There are many anti-theft systems that have the purpose of preventing theft of i.a., electric apparatus. Many of these systems are based on the use of alarms which are activated by movements detected by a motion sensor. A drawback of these systems is that electric apparatus may be stolen and used at other places than where they have been stolen from.

The U.S. Patent Application Publication 2005/0242918 A1 discloses a system for securing electric apparatus. This system includes a plurality of electric apparatus which are mutual connected via a communication medium through which two-way communication can take place. Furthermore, each electric apparatus contains a transmitter as well as a receiver.

Thus, a number of drawbacks are associated with the use of this system. Firstly, the system presupposes the use of several apparatus which are interconnected via a communication medium. Therefore, the system does not work if only one electric apparatus is used. Besides, all electric apparatus are to be equipped with a transmitter as well as a receiver. This is resource demanding and unnecessarily complicated. Thirdly, it is impractical that one electric apparatus controls the other electric apparatus, since the controlling apparatus thereby becomes indispensable. If the controlling apparatus is stolen or removed, the system will consequently not work.

However, these drawbacks can be relieved by using a security system under the action of which electric apparatus can only function in the local area in which they are installed. In the following, such a technical solution can be described.

International Patent Application Publication WO 2004/077371A1 concerns an electric or electronic apparatus that comprises a switch-on circuit, which only allows the switching-on of the apparatus when the switch-on circuit receives an activation signal, either by wireless or through a wired connection, and is provided with a verification unit built into the apparatus or an external verification unit. The verification unit cooperates with the switch-on circuit for the supplying of the activation signal to the switch-on circuit after execution of the correct verification to allow the switching-on of the apparatus. The apparatus further includes a data input unit configured as a magnetic card reader, a chip card reader or a data connection to an external data register for the input of identification data from the magnetic card, chip card or external data register and for the transfer of these data to the verification unit, in which the verification of the authenticity of the transferred data is performed in order to cause, by verifying correctly, the generating of the activation signal for the supplying of the signal to the switch-on circuit for the switching on of the electric or electronic apparatus

International Patent Application Publication WO 00/34929A1 relates to a disabling system for disabling an electrical device when the device is removed from a selected zone. The system includes a master unit which contains transmitter means for transmitting an enabling signal in the zone and at least one slave unit, which is operable, connected to an electrical device. The enabling signal is typically transmitted via an electrical installation in the zone. The slave unit includes a receiver means for receiving the enabling signal when the electrical device is in the selected zone, and a disabling means for disabling the device when the enabling signal is not received thereby to disable the device when it is removed from the zone. The invention also extends to a method of disabling an electrical device when the device is removed from the selected zone, and to a master unit and a corresponding slave unit for the disabling system.

UK Patent Application Publication GB 2 229 025A also discloses a security system for electric apparatus for, e.g., CD-players, TV-receivers, video recorders and hi-fi systems. Each electric apparatus is provided with a receiver allowing use of the apparatus if a defined signal has been received which will not be generated if theft has occurred. A transmitter circuit is connected to the 220 V network, applying a predefined signal to the existing 220 V network. The transmitter contains a processing unit that communicates with data input means, whereby an individual identification number for each electric apparatus connected to the 220 V network is saved in a memory. These identification numbers are sequentially superimposed on the 220 V network, causing the electric apparatus to be released by connecting to the network.

### SUMMARY OF THE INVENTION

The object of the present invention is to prevent electric apparatus from being used in other places than where application is intended by simple means in the form of a one-way communication, whereby a second object is that apparatus lose their practical value if they are stolen.

According to the present invention, this is achieved with a system of the type mentioned in the introduction, which is distinguished by the fact that activation of the electric apparatus can be conditional on the transmitter transmitting the coded signal and that at least one decoder may receive the coded signal, where the decoder may interact with at least one electronic switch for establishing power supply to the apparatus.

The method according to the invention is distinguished by the fact that the electric apparatus may be supplied with power when a decoder receives and decodes a signal transmitted form at least one transmitter, where missing decoding of a signal results in breaking of an electric circuit in the apparatus.

With a system according to the invention there is thus achieved a securing of electric apparatus which is hidden and functional. When signals are transmitted by a transmitter, at least one decoder will receive and decode these signals. By using a device that switches off the power supply or other essential electric circuit for the electric apparatus in case that the decoder does not receive and decode the transmitted signals, it is possible to protect electric apparatus very efficiently against theft. The security is provided in that the equipment is not usable and thereby saleable when it has been moved in connection with theft. The system can be used on all electronic equipment and at the same time is easy to install. By using marking in the firm, the thief is made aware that the electric apparatus are secured. Such marking may be put on the relevant electric apparatus and on central places, such as doors and windows.

By a method according to the invention there is achieved a very efficient securing of electric apparatus. The method can be used on all electric apparatus. The method prevents theft because the apparatus do not function if they are stolen and attempted used in other places. The method may advantageously be used by small as well as large firms, since there is no maintenance as such associated with the systems. The electric apparatus are secured from the moment the system is activated. The method also has the advantage that it may cover a large number of apparatus at the same time.

By “transmitter” as used in the present application is meant any device which is capable of transmitting a signal. Thus, it does not need to be a certain type of signals. There may be used, e.g., radio waves (e.g., via a mobile network), sound waves or signals transmitted via an electric network.

By “decoder” as used in the present application is meant any device which is capable of receiving and decoding a signal. It may be, e.g., a small chip which can be integrated in an electric apparatus. It may be, e.g., be a larger receiver box which may be programmable.

By “electric apparatus” as used in the present application is meant any apparatus powered by electricity. It may thus be apparatus that may be connected to an electric network, and apparatus that are entirely or partly battery-powered. Electric apparatus include, i.a., televisions, computers, (stationary as well as laptops), telephones, monitors, music systems, refrigerators, freezers, cooking ranges, ovens, game machines, copying machines and scanners.

According to a particular embodiment, the present invention is distinguished in that at least one decoder for decoding the signals transmitted by the at least one transmitter is integrated in at least one electric apparatus. Such an embodiment is advantageous because an integrated decoder may be built into the electric apparatus. An integrated decoder may be placed inside the apparatus and thus be hidden.

According to a further embodiment, the present invention is distinguished in that the at least one decoder for decoding the signals transmitted by the at least one transmitter consists of at least one chip which can be placed in an electric apparatus. Such an embodiment has the advantage that the chip can be placed at various points in an electric apparatus. In a computer at least one chip may be, e.g., placed in connection with the power supply, so that the power supply only works when a chip receives the correct signals. There may also be placed a chip on one of the other parts of the computer, e.g., the hard drive, whereby the part on which a chip is mounted only operates when the chip is receiving the correct signals.

According to a further embodiment, the present invention is distinguished in that the system may include at least one decoder for decoding the signals transmitted by the transmitter, the decoder being designed as an external unit which transmits signals to the apparatus, where the apparatus contains means for decoding the signal.

Such an embodiment has the advantage that at least one additional decoder may communicate with another decoder. By providing a decoder in an electric apparatus and letting this decoder receive signals from a second decoder that receives signals from a transmitter, it is possible to insert a further check. There may, e.g., be used types of decoders receiving signals from a centrally disposed transmitter. If this decoder is removed, the electric apparatus will not function. By removing this single decoder it is possible for a person in that way to prevent others from using, e.g., a personal computer with confidential information.

According to a preferred embodiment, the present invention is distinguished in that at least one transmitter transmits signals to the at least one decoder via at least one power network. Such an embodiment has the advantage of using types of decoders which can be disposed in a power socket, from where they receive signals transmitted via the electric network from a transmitter provided in connection with the local control board. If this decoder disposed in the power socket is removed, the electric apparatus will not function. This may be applied in cases where a person desires to prevent others from using an electric apparatus. The presence of such decoders will also have a preventive effect, as a potential thief may see that the electric apparatus in question is included in a particularly efficient theft protection.

According to a preferred embodiment, the present invention is distinguished in that the at least one transmitter may be activated via at least one code at installation or if the power disappears. Such an embodiment has the advantage that the user of the system has the opportunity to engage and disengage the system by using one or more codes. If a person wants to prevent that a number of electric apparatus which are secured through the present invention, it may performed by means of these codes. Such an embodiment furthermore has the advantage that the transmitter can be activated in many ways. The transmitter may, e.g., be activated through one or more codes which are keyed in through the internet, manually or by mobile phone. The transmitter may thus be programmable and controllable through a number of different forms of signal communication.

According to a preferred embodiment, the present invention is distinguished in that at least one decoder receives signals from the at least one transmitter via a wireless network, which may be Global System for Mobile Communications (GSM). Such an embodiment has the advantage that communication via GSM is long-range. This technique may thus advantageously be applied in connection with portable apparatus, such as laptops. The technique will also be usable when an electric apparatus is moved, e.g., in connection with repair.

According to a preferred embodiment, the present invention is distinguished in that one decoder may simultaneously receive signals from at least one transmitter via several forms of communication, such as via GSM, via the power network or via a radio transmitter. Such a combination will be advantageous in many situations. Firstly, such a solution will be less vulnerable to technical failure, as one may use a solution where the decoder is only to receive signals from one of the said forms of communication. Secondly, it will be possible to change between the various forms of communication depending on the need. If an electric apparatus is, e.g., to move in connection with repair, it will be expedient to use communication via GSM instead of, e.g., communication via the power network.

According to a further embodiment, the invention is distinguished in that the transmitter can be mounted on a control board. Through the power network, the transmitter can transmit signals around to all power sockets. If the system is used for securing electric apparatus containing network cards, it may be suitable to use the unique serial number on network cards, the so-called MAC-address which is 6 digits (expressed in the hexadecimal number system) printed by the producer. By using a system which is limited upwards with regard to the number of users, it will be possible to avoid unauthorized use of the system. Such a solution may provide a specific system protection directed against a limited number of apparatus.

According to yet an embodiment, the present invention is distinguished in that the decoder can be designed as a chip which, at installation, can be glued to the electronic apparatus which is desired to be protected. This may be done by bonding the chip securely on the part of the apparatus which is responsible for supplying the apparatus with power. Such a solution has the advantage that the same installation principle can be applied in connection with very many electric apparatus. Furthermore, this method is simple and very safe. The glue for this purpose may be a very strong two-component adhesive “melting” the chip and the equipment together, without possibility of separating them again. A possibly type of adhesive may be Arifix 190 which is activated with a catalyst 20. In connection with the said technique, the chip circuit will be “open”, whereby the apparatus receives power when the chip receives the correct signals. Depending on whether one or more decoders are used, these signals may stem directly from the transmitter or from another decoder which has transmitted signals after having received signals from the transmitter. Besides, it will be possible to incorporate a chip in electric apparatus when they are produced.

According to a preferred embodiment, the system is distinguished in that at least one on/off-mechanism is controlled by at least one decoder. Such an on/off switching mechanism may ensure that the electric apparatus can be turned on and off in connection with the at least one decoder receiving or not receiving, respectively, the required signals. Such an on/off mechanism may be formed by a chip fitted in connection with the electric apparatus.

The invention will now be explained more closely in the following with reference to the accompanying schematic drawings.

### BRIEF DESCRIPTION OF THE DRAWINGS

FIG. 1 is a schematic view of an embodiment of a system for securing electric apparatus;

FIG. 2 is a schematic view of a second embodiment of a system for securing electric apparatus.

### DETAILED DESCRIPTION OF THE INVENTION

Firstly, it is to be noted that the attached drawings only illustrate non-limiting embodiments of the invention. Other embodiments will be possible within the scope of the present invention.

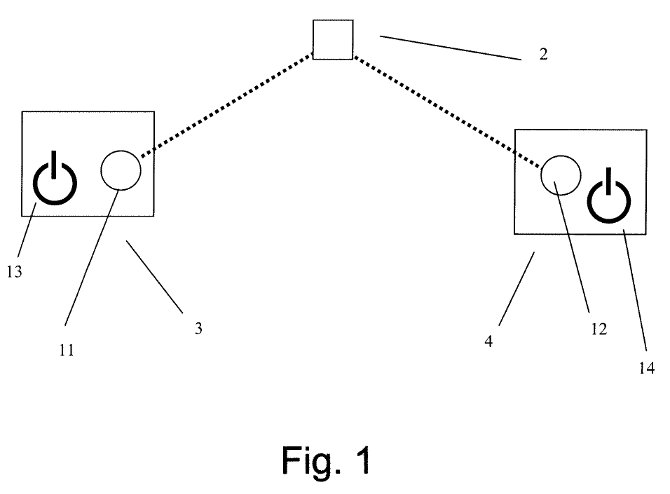

FIG. 1 shows a first embodiment of a system for securing electric apparatus. The system includes a transmitter (2) and decoders (11, 12) which are integrated in the electric apparatus (3, 4). The signals from the transmitter (2) are conducted wirelessly from the transmitter (2) to decoders (11, 12). The decoders (11, 12) are capable of connecting and disconnecting the power supply to the apparatus (3, 4) via on/off mechanisms (13, 14).

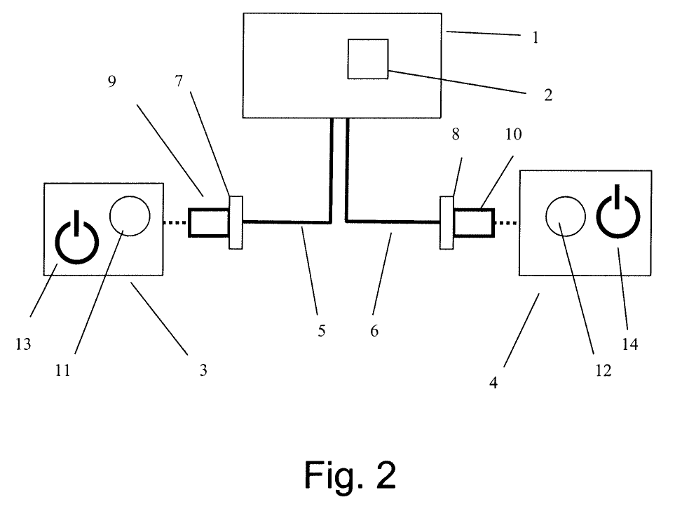

FIG. 2 shows a further embodiment of a system for securing electric apparatus. The system includes a transmitter (2) and four decoders (9, 10, 11, 12), of which two decoders (9, 10) receive signals from the transmitter (2) and transmits signals to two additional decoders (11, 12) which are integrated in the electric apparatus (3, 4). The two decoders (9, 10) are connected to the power network (5, 6) via power sockets (7, 8). The signals from the transmitter (2), which is provided in connection with the control board (1), are thus conducted via the power network from the transmitter (2) to the power sockets (7, 8). Here, the signals are received by two decoders (9, 10) which transmit signals to additional decoders (11, 12). These decoders (11, 12) are capable of connecting and disconnecting the power supply to/from the apparatus (3, 4) via on/off mechanisms (13, 14).

What is claimed is:

1. A system for securing electric apparatuses, the system including at least one transmitter, the transmitter transmitting at least one coded signal, where the system includes at least one electric apparatus, the apparatus interacting with at least one decoder, whereby activation of the electric apparatus is conditional on the transmitter transmitting the at least one coded signal which is received at least the one decoder, and where the at least one decoder interacts with at least one electronic switch for establishing power supply to the apparatus.

2. System according to claim 1, whereby the at least one decoder for decoding the signals transmitted by the transmitter is integrated in at least one electric apparatus.

3. System according to claim 1, wherein the at least one decoder is an external unit which transmits signals to the apparatus, where the apparatus contains means for decoding the signal.

4. System according to claim 3, whereby the transmitter is adapted to be activated via at least one code at one of installation and if the power disappears.

5. System according to claim 4, whereby said at least one transmitter is adapted to transmit signals to the at least one decoder via at least one electric network.

6. System according to claim 4, whereby the decoder is adapted to receive signals from the at least one transmitter via a wireless network.

7. (canceled)

8. Method according to claim 12, whereby the transmitter transmits signals to the at least one decoder via at least one electric network.

9. Method according to claim 8, whereby the method includes the application of means for decoding the signals transmitted by the transmitter using an external unit which transmits signals to the apparatus, where the signals from the external unit are decoded by a means for decoding in the apparatus.

10. Method according to claim 9, whereby the transmitter is activated via at the least one code at one of installation and if the power disappears.

11. Method according to claim 12, whereby the decoder receives signals from the at least one transmitter via a wireless network.

12. A method for securing electric apparatuses, comprising the steps of:
transmitting coded signals from at least one transmitter;
using at least one decoder at least one electric apparatus for receiving said coded signals, and
supplying the at least one electric apparatus with power when the at least one decoder receives and decodes the coded signals transmitted from the at least one transmitter, and
breaking of an electric circuit in the apparatus when the decoder fails to receive the coded signal from the at least one transmitter.
